(19) United States
(12) Patent Application Publication
(10) Pub. No.: US 2006/0007910 A1
(43) Pub. Date: Jan. 12, 2006

(54) Mapping of network configuration data to network interfaces

(76) Inventor: Daniel Scheibli, Karlsruhe (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/172,999

(22) Filed: Jul. 5, 2005

(30) Foreign Application Priority Data
Jul. 9, 2004 (EP) 04 016 208.3

(51) Int. Cl. H04L 12/28

(52) U.S. Cl. 370/351

(57) ABSTRACT

Network interfaces within a computer, which are connected to at least one physical network, are provided with logical network configuration data. The network interfaces may receive logical network identification information from the physical network. Network configuration data are then mapped onto the network interfaces based on the received logical network identification information to enable the network interfaces to provide communication between the computer and the corresponding logical network. Thus, a network interface card may be automatically configured to a logical network.

### TECHNICAL FIELD

The present invention relates in general to a method for providing a network interface within a computer with logical network configuration data, where the computer is connected via the network interface to at least one physical network.

The invention also relates in general to a computer arranged for providing a network interface with logical network configuration data.

The invention further relates in general to a computer-readable medium having computer program instructions thereon for providing a network interface within a computer with logical network configuration data.

### RELATED APPLICATIONS

Priority is claimed to European Patent Application No. EP 04 016 208.3, filed Jul. 9, 2004, the content of which is incorporated herein by reference.

### BACKGROUND

In distributed computer environments, such as local area networks (LAN), computers are connected with each other over physical networks. A physical network may, for instance, be a collection of cables and network switches that enable the computers of the network to be connected. The physical network may be understood, for example, as the lowest communication layer of a network. It may, insofar, be understood as the physical representation of the devices connecting the different computers with each other.

Network interface cards (NIC) may be installed within the computers for connecting the computers to the physical networks. These network interface cards allow the computers to be connected to the network, for instance, through switches. The NICs together with other necessary network infrastructures enable communication between computers. The connection to switches or routers may be hardwired or established via air interfaces. Various protocols, such as Ethernet, W-LAN, 802.11, and other communication protocols may be used.

The network interface cards need to be installed properly in order to allow proper communication over a physical network. For instance, the cards need to be physically plugged in and an operating system driver needs to be properly installed and configured. The operating parameters of the network interface cards may, for instance, be stored within network configuration data. A network configuration may be a single set of data, which may be required to allow communicating over a network with other computers. For instance, information about the internet protocol (IP) address, a netmask, a broadcast address, and a default gateway may be necessary, in situations where the communication protocol is TCP/IP. Other network protocols are also possible, where each network protocol requires particular network configuration data for the network interface cards to be set up with the appropriate parameters.

Operating systems within the computers provide binding of protocols to network interface cards to enable these protocols to be run on the network interface cards. When a particular type of protocol is running, the respective network configuration data is bound to the network interface. The network interface may then provide communication with the corresponding protocol over the network.

In known systems, network interface cards may be accessed by the operating system through a service access point. The logical representation of a network interface within the operating system may be established by logical symbols, for example, identifying service access points. Current systems allow static mapping of network configuration data onto respective service access points. The respective network configuration for a service access point needs to be selected manually by a user. In this way, the network configuration of a network interface card within a computer in current systems is fixed to one protocol. In other words, network configuration data is permanently mapped to a service access point of a network interface card. Changing the mapping of network configuration to a different service access point or changing the mapping of a service access point to a particular protocol needs to be performed manually. Additionally, configuration parameters need to be adapted to the new protocol and manual binding of protocol to network interface card is required.

Accordingly, in known systems, there is the drawback that after disconnecting a network interface card from a network physically, and subsequently connecting a different network to the network interface card, changes to the network configuration may not be carried out automatically. A user has to manually select, for example, which network configuration to use. These problems become even more severe in situations where more than one physical network is connected to different network interface cards within one computer. In such a case, it might happen that the different connection cables may become mixed up after disconnecting and during reconnecting. As a result, none of the network cards may work properly, as none is configured correctly.

Problems may also occur in situations where different logical networks are operated within one physical network. A logical network may be formed by a group of computers communicating with each other. For instance, a TCP/IP subnet may provide a logical network within a physical network. The computers of a logical network may share a common feature. This may, for example, be a common subnet configuration. As another example, certain services may be operated within one certain IP-address range. These services may, for instance, be a storage network, a server network, or a client network. A logical network may be a storage network, a server network, a client network, or any other network. Each of these logical networks may run on the same physical network, while sharing different configuration features, such as subnet configurations or other network configuration parameters. To configure one certain computer for one of these logical networks, the respective network configuration has to be chosen. The role of a computer, such as which logical network it is operated in, may change during operation. In such a case, the computer needs to be reconfigured in known systems. Reconfiguring the computer manually may be error prone.

### SUMMARY

Consistent with the principles of the present invention, a method involves providing a network interface within a computer, which is connected via the network interface to at least one physical network, with logical network configuration data. The computer may map network configuration data onto the network interface corresponding to the received logical network identification, in order to enable the network interface to provide communication between the computer and the corresponding logical network.

According to embodiments consistent with the present invention, network configuration data may be mapped onto the network interface, for example, the network interface card, or its logical representation such as its service access point, depending on the logical network the interface should be run in. Based on logical network identifiers received within the network interfaces, respective configuration data may be mapped onto this network interface or its logical representation.

According to embodiments consistent with the present invention, de-coupling of the network configuration from the actual network interface is provided. The network interface may be a network interface card. No static mapping between a logical representation of the network interface, for example, a service access point of a network interface, and a network configuration data set is required. Instead, some embodiments in accordance with the present invention provide mapping configuration data for different logical networks to network interfaces automatically, depending on the network identification received over the respective network interface.

A user may define which logical network the computer is allowed to be operating in. A mapping between the network configuration data and the respective logical network may, in such a case, be carried out automatically through a mapping unit. This mapping, however, depends on the network identifier received over the respective network interface. The mapping unit maps the logical network configuration data onto the network interface or its service access point corresponding to the received network identification.

There is no need to define which network interface to operate within which logical network. To achieve correct configuration, each logical network may transmit a logical network identification information over the physical network. A network interface card coupled to a particular physical network may receive, via this connection, the logical network identification information. After having received the respective logical network identification information, the receiving network interface card may be configured to be operated within this logical network. This configuration may be done by mapping the corresponding network configuration data to the network interface or its corresponding service access point. Configuration of network interfaces may thus be carried out automatically. The only requirement for enabling the appropriate mapping of logical network configuration data to the respective network interface is to receive logical network identification information via the physical network.

Assignment of network configuration and wiring of the cables of the physical networks to the respective network interfaces may be carried out separately from each other. Plugging the correct cable into the correct network interface card is not necessary anymore. Mixed up cables may be accounted for automatically by configuring the network interface through its service access points with the appropriate logical network configuration upon reception of logical network identification information. In this way, changing physical cable connections may be tolerated with few or no errors.

Different operating systems may detect devices, for instance, network interface cards, during booting in different orders. In some embodiments in accordance with the present invention, detection of installed network interface cards in different orders may not disturb network configuration. The network configuration may be independent of the respective service access point. Any mapping between service access point and network configuration data may be possible. The network interface needs only to receive logical network identification information to allow automatic mapping between configuration data and network interface.

Furthermore, logical networks may be moved from one physical network to another. The respective connected network interfaces may be configured to the appropriate logical network during operation, for example, by using the logical network identification information that enables mapping of logical network configuration to network interfaces. For instance, it may be possible to introduce a further physical network and run a particular logical network on this physical network rather than running two different logical networks over one single physical network. This may be appropriate in case traffic on the physical network increases and proper operation is disturbed. The only requirement may be that the user needs to determine which logical networks the computer is allowed to be operated in.

In addition, it may be possible to run one single logical network on multiple physical network interfaces. This may result in high availability of the logical network. Some embodiments in accordance with the present invention may sending the same logical network identification information on each physical network, allowing mapping of each of the network interfaces connected to the different physical networks to the network configuration data of the same logical network.

Some embodiments in accordance with the present invention provides routing of the received logical network identification to a mapping unit located with the computer for mapping the network configuration data onto the network interface or its respective service access point, based on the received logical network identification. The mapping unit may thus provide automatic and dynamic configuration of network interfaces.

It may also be possible to providing at least two logical network configuration data sets, where each logical network configuration data set enables the network interface to provide communication between the computer and the corresponding logical network. According to some embodiments, different logical networks may be run on one physical network. Moreover, more than one network interface may be configured with a respective logical network configuration.

To allow quick access to logical network configuration, some embodiments provide storing of the network configuration data within the computer and accessing the required network configuration data when mapping the network configuration data onto the network interface. In accordance with these embodiments, mapping may be carried out quickly. The network configuration may be done by an administrator and stored within the respective computers. Configuration of the network interfaces may only require loading the network configuration data after reception of logical network identification information. No manual interaction is necessary.

It may also be possible, according to some embodiments, to request network configuration data from a server located within the physical and/or the logical network after having received the logical network identification. In such a case, the network may operate a server, which may be a domain name server (DNS) or a dynamic host configuration protocol (DHCP) server. After having received the network identification, the respective network interface may broadcast a DHCP request within the connected logical network. A DHCP server within this logical network may provide the network interface with network configuration data in a DHCP response. This network configuration data may be stored within the computer and used for configuring the network interface.

Running more than one logical network on a single physical network may be provided, according to some embodiments in accordance with the present invention, by providing at least two network interface identifications for one network interface and mapping the network configuration data onto the network interface with the corresponding identification after having received the logical network identification. As an example, a computer may be identified by a particular network identification. A service running on this computer may be identified by another particular network identification. These different network identifications may be utilised for network interface identification. This may be done, for example, by using two different IP-addresses for the computer and the service running on the computer. Using these two different identifications, one single network interface may be used for working on different logical networks. For each of the identifications, a mapping to the respective network configuration data for configuring the network interface may be carried out. For example, each identification may be represented by a respective service access point, which may be configured using the described mapping.

A so-called promisc mode may be used within the network interfaces for the initialisation of the logical network and for mapping the network interface onto the logical network configuration data for the respective logical network. In the so called promisc mode in accordance with some embodiments of the present invention, the network interface may be operated such that it may receive every message within the network and that it may route every message to the operating system of the computer.

The operating system may decide, whether the received message is a logical network identification information. It may then initiate mapping of configuration data to network interface. After having configured the network interface accordingly, the promisc mode may be turned off, to reduce traffic on the operating system.

In normal mode, only messages intended for the respective computer or service are routed through the network interface to the operating system. Messages not intended for the computer or service, for instance, messages intended for a different logical network, may be blocked or filtered within the network interface. However, broadcast messages may be used for transporting logical network identification information. These broadcast messages may be routed at any time from the network interface to the operating system. For example, such broadcast messages may allow mapping of a network interface to be switched from one particular logical network configuration to a different logical network configuration.

Some network interfaces may be in a listen mode. These network interfaces may receive and process every message on the network, for example, by analysing each data token on the network. Network interfaces in a listen mode include those interfaces that are not yet configured properly. To access only the network interfaces that have not yet been configured and thus are in listen mode, some embodiments in accordance with the present invention utilize transmission of faulty broadcasts. Faulty broadcasts may be messages that are only processed by those network interfaces, which are in a listen mode. Network interfaces that are running in normal mode may ignore these messages. Faulty messages may reduce message overhead on already configured network interfaces as they are only processed by network interfaces in listen mode.

Some embodiments provide running a unit within the physical network in order to allow identification of a logical network and broadcasting of the logical network identification throughout a physical network, which then transmits the logical network identification into the network. This unit may, for example, be a tagging unit. This unit may send a logical network identification information message for each logical network, in intervals of, for example every second, every ten seconds, every minute or any other interval. Using these messages, the unit identifies the logical network running within the physical network. A computer connected to the physical network through a network interface may receive this logical network identification information message and may identify which logical networks are running on top of the respective physical networks. The network interfaces of the computer may then be configured accordingly.

Another aspect consistent with the present invention is a computer arranged for providing a network interface with logical network configuration data, in particular according to a method described above. The computer includes at least one network interface card that interfaces the computer with at least one physical network, a storage arranged for storing at least one logical network configuration data set, and a mapping unit for mapping a network configuration data onto the network interface card. The mapping unit of the computer is arranged for mapping network configuration data onto the network interface card after reception of a corresponding logical network identification in order to enable the network interface card to provide communication between the computer and the corresponding logical network.

A further aspect is a computer program for providing network interfaces within a computer with logical network configuration data. The program includes instructions for causing the computer to receive within the network interface from a physical network logical network identification information, and to map network configuration data onto the network interface corresponding to the received logical network identification. In this way, the computer program enables the network interface to provide communication between the computer and the corresponding logical network.

A computer program product is provided in yet another aspect for providing network interfaces within a computer with logical network configuration data. The computer program product has stored thereon a computer program where the computer program includes instructions operable to cause the computer to receive, within the network interface, from a physical network, logical network identification information, and to map network configuration data onto the network interface corresponding to the received logical network identification. Thus, the computer program product enables the network interface to provide communication between the computer and the corresponding logical network.

All features of the dependent claims may be implemented as embodiments of independent claims within different categories in accordance with the present invention. In particular, the features according to the method may be incorporated structurally within the apparatus by appropriate means arranged for implementing the respective method steps.

Further features and embodiments of the present invention will become apparent from the description and the accompanying drawings. It will be understood that the features mentioned above and those described hereinafter may be used not only in the combination specified but also in other combinations or on their own, without departing from the scope of the present invention. It will also be understood that the foregoing background, summary, and the following description of the embodiment are in no way limiting on the scope of the present invention and are merely illustrations of a preferred embodiment of the present invention.

### BRIEF DESCRIPTION OF THE DRAWINGS

Referring now to the drawings, in which like numerals represent like elements throughout the several figures, aspects of the present invention and the exemplary operating environment will be described.

FIG. 1 shows a computer system for implementing a method consistent with the present invention.

FIG. 2 shows another computer system for implementing a method consistent with the present invention.

FIG. 3 shows yet another computer system for implementing a method consistent with the present invention.

FIG. 4 shows layers of a reference model for implementing a method consistent with the present invention.

FIG. 5 shows a flowchart of a method consistent with the present invention.

### DETAILED DESCRIPTION

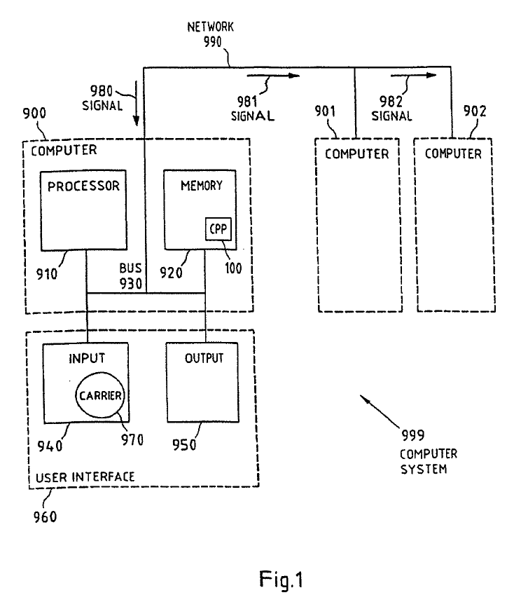

FIG. 1 illustrates a simplified block diagram of exemplary computer system 999 having a plurality of computers 900, 901, 902.

Computer 900 is capable of communicating with computers 901 and 902 over network 990. Computer 900 has processor 910, memory 920, bus 930, and, optionally, input device 940 and output device 950. Computer 900 may additionally include any I/O devices and interfaces such as user interface 960. As illustrated, the invention is implemented by computer program product 100 (CPP), carrier 970 and signal 980.

In respect to computer 900, computers 901 and 902 are sometimes referred to as “remote computers.” Computer 901 or 902 may be, for example, a server, a peer device or other common network node, and typically has many or all of the elements described in connection with computer 900.

Computer 900 is, for example, a conventional personal computer (PC), a desktop device or a hand-held device, a multiprocessor computer, a pen computer, a microprocessor-based or programmable consumer electronics device, a minicomputer, a mainframe computer, a personal mobile computing device, a mobile phone, a portable or stationary personal computer, a palmtop computer or any other suitable device.

Processor 910 is, for example, a central processing unit (CPU), a micro-controller unit (MCU), digital signal processor (DSP), or the like.

Memory 920 is an element that temporarily or permanently stores data and instructions. While memory 920 is illustrated as a part of computer 900, memory 920 may also be implemented in network 990, in computers 901 and 902, and in processor 910 (e.g., cache, register), or in another suitable component of computer system 999. Memory 920 may be a read only memory (ROM), a random access memory (RAM), or a memory with other access options. Memory 920 is physically implemented by computer-readable media, such as, for example, (a) magnetic media, like a hard disk, a floppy disk, or other magnetic disk, a tape, a cassette tape; (b) optical media, like optical disk (CD-ROM, digital versatile disk-DVD); (c) semiconductor media, like DRAM, SRAM, EPROM, EEPROM, memory stick.

Optionally, memory 920 may be distributed. Portions of memory 920 may be removable or non-removable. Computer 900 may use well-known devices, such as, for example, disk drives, or tape drives, for reading from media and for writing in media.

Memory 920 stores modules such as, for example, a basic input output system (BIOS), an operating system (OS), a program library, a compiler, an interpreter, and a text-processing tool. Modules are commercially available and may be installed on computer 900. For simplicity, these modules are not illustrated.

CPP 100 has program instructions and, optionally, may also have data, that cause processor 910 to execute method steps in accordance with some embodiments of the present invention. In other words, CPP 100 may control the operation of computer 900 and its interaction in network system 999 so that it operates to perform in accordance with the invention. As an example, CPP 100 may be available as source code in any programming language, and as object code (“binary code”) in a compiled form.

Although CPP 100 is illustrated as being stored in memory 920, CPP 100 may be located elsewhere. For example, CPP 100 may also be embodied in carrier 970.

Carrier 970 is illustrated outside computer 900. For communication between CPP 100 and computer 900, carrier 970 is conveniently inserted into input device 940. Carrier 970 may be implemented as any computer readable medium, such as a medium largely explained above (cf. memory 920). Generally, carrier 970 is an article of manufacture having a computer readable medium with computer readable program code written thereon to cause the computer to perform methods of the present invention. In addition, signal 980 may also embody computer program product 100.

While one suitable arrangement of CPP 100, carrier 970, and signal 980 in connection with computer 900 is described above, further carriers and further signals embodying computer program products (CPP) to be executed by further processors in computers 901 and 902 may also be implemented.

Input device 940 provides data and instructions for processing by computer 900. Device 940 may be a keyboard, a pointing device (e.g., mouse, trackball, cursor direction keys), microphone, joystick, game pad, scanner, or disc drive. Although the examples are devices capable of human interactions, device 940 may also be a device without human interaction capabilities, such as, for example, a wireless receiver (e.g., with satellite dish or terrestrial antenna), a sensor (e.g., a thermometer), a counter (e.g., a goods counter in a factory), or another suitable device. Input device 940 may serve to read carrier 970.

Output device 950 presents instructions and data that have been processed. For example, output device 950 may be a monitor or a display, (cathode ray tube (CRT), flat panel display, liquid crystal display (LCD), speaker, printer, plotter, vibration alert device, or another suitable output device. Output device 950 may communicate with the user and/or communicate with further computers.

Input device 940 and output device 950 may be combined into a single device. Any devices 940 and 950 may be provided optional.

Bus 930 and network 990 provide logical and physical connections by conveying instructions and data signals. While connections inside computer 900 are conveniently referred to as “bus 930,” connections between computers 900-902 are referred to as “network 990.” Optionally, network 990 includes gateways, which are computers that specialize in data transmission and protocol conversion.

Devices 940 and 950 are coupled to computer 900 by bus 930 (as illustrated) or by network 990 (optional). While the signals inside computer 900 are mostly electrical signals, the signals in the network may be electrical, electromagnetic, optical, wireless (radio), or of any other suitable signal type.

Networks are commonplace in offices, enterprise-wide computer networks, intranets, and the Internet (e.g., world wide web). Network 990 may be a wired or a wireless network. To name a few network implementations, network 990 may be, for example, a local area network (LAN), a wide area network (WAN), a public switched telephone network (PSTN), an Integrated Services Digital Network (ISDN), an infra-red (IR) link, a radio link such as an Universal Mobile Telecommunications System (UMTS), Global System for Mobile Communication (GSM), Code Division Multiple Access (CDMA), or a satellite link.

A variety of transmission protocols, data formats and conventions are known. These may include, for example, transmission control protocol/internet protocol (TCP/IP), hypertext transfer protocol (HTTP), secure HTTP, wireless application protocol (WAP), unique resource locator (URL), a unique resource identifier (URI), hypertext markup language (HTML), extensible markup language (XML), extensible hypertext markup language (XHTML), wireless markup language (WML), Standard Generalized Markup Language (SGML), and any other suitable protocols.

Interfaces coupled between the elements are also well known in the art. For simplicity, interfaces are not illustrated. An interface may be, for example, a serial port interface, a parallel port interface, a game port, a universal serial bus (USB) interface, an internal or external modem, a video adapter, a sound card, or any other suitable interface.

Computer and program are closely related. As used hereinafter, phrases, such as “the computer provides” and “the program provides,” are convenient abbreviation to express actions by a computer that is controlled by a program.

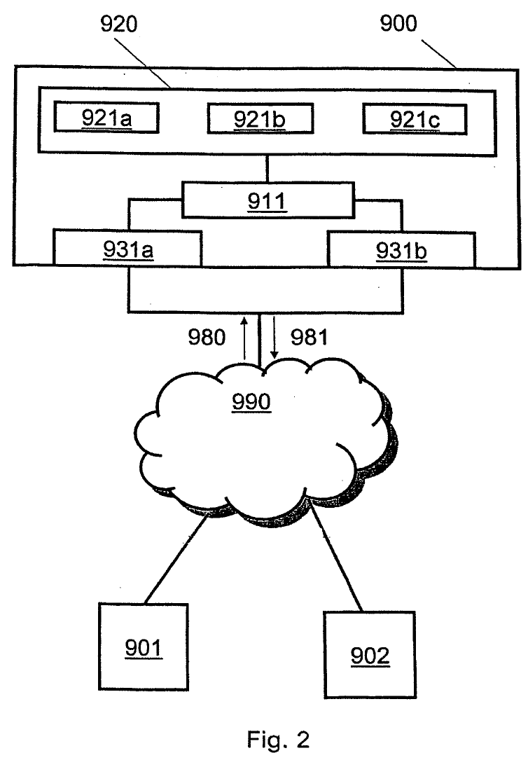

FIG. 2 shows a computer system arranged for implementing a method in accordance with the present invention. Shown are computer 900 comprising memory 920, mapping unit 911, and network interface cards 931a and 931b. Memory 920 may store different logical network configuration data sets, such ad data sets 921a, b, c. Memory 920 is connected to mapping unit 911. Mapping unit 911 is connected to network interface cards 931.

Computer 900 is connected via network interface cards 931a, b to physical network 990. Computer 900 may receive messages 980 from network 990 and send messages 981 into network 990. Within network 990, a tagging unit 901 and/or a DHCP server 902 may be located.

Each of the network interface cards 931a and 931b may have a separate physical connection to a network 990. After connecting one of the network interface cards 931a and 931b to network 990, the network interface cards 931 may listen for messages comprising logical network identification information.

Received messages, in particular broadcast messages, may be routed through the network interface card to the operating system (OS) running on the computer 990. The OS may be located within CPP 100 (not depicted). The operating system or CPP 100 (not depicted) may decide, whether the respective message comprises logical network identification information. In case logical network identification information is detected, the operating system may control mapping unit 911 insofar that a corresponding logical network configuration data 921 is retrieved from memory 920. In this way, mapping unit 911 may be controlled by CPP 100 to map a corresponding logical network configuration onto the respective network interface card 931. Network interface card 931 may then be operated within the respective logical network with the appropriate network configuration.

Tagging unit 901 may be connected to network 990 to allow transmission of logical network identification information into the network 990. Tagging unit 901 may broadcast network identification information messages, which may be received by network interface cards 931, in intervals (e.g., every second). Using the network identification information messages, appropriate configuration with logical network configuration data may be possible through mapping unit 911, automatically.

In situations where network interface card 931b receives, in a message 980, a logical network identification information determining the logical network as server network, network interface card 931b may route this message to the operating system. The operating system may operate mapping unit 911 to retrieve the respective logical network configuration data 921 for a server network.

In the event the respective data is not available entirely within memory 920, for instance, when only configuration data that is to be retrieved via a DHCP request is available, network interface card 931b may request, via message 981, DHCP server 902 within a DHCP request message, to provide the respective network configuration data. DHCP server 902 may transmit the corresponding logical network configuration data to network interface card 931b through network 990 within message 980. Network interface card 931b may retrieve the DHCP response message, and provide memory 920 with the logical network configuration data. The stored logical network configuration data may then be mapped onto network interface card 931b to operate network interface card 931b within the respective logical network.

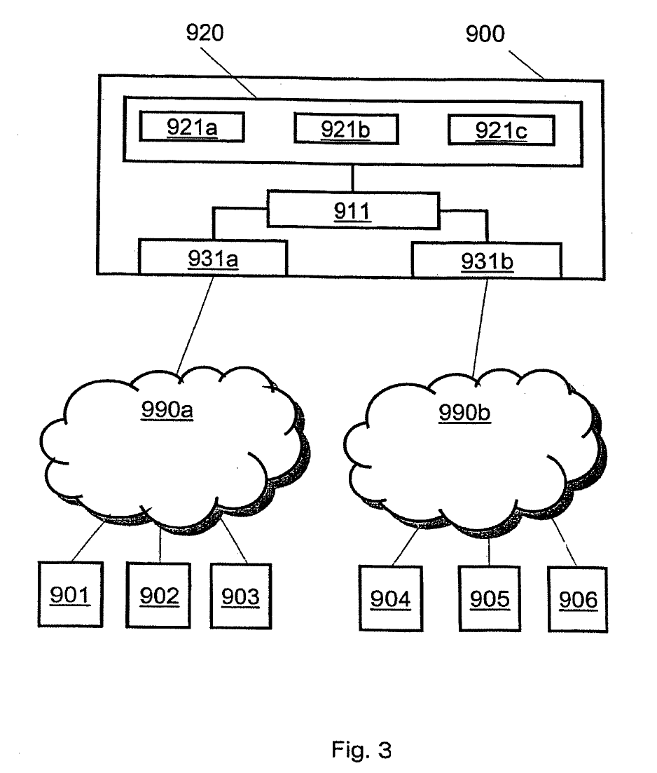

FIG. 3 shows a network environment, in which computer 900 is connected to different physical networks 990a and 990b. When connecting network interface cards 931a and 931b to the networks 990a and 990b, it may not be known which logical networks are run on the physical networks 990a and 990b. To allow configuration of the network interface cards 931a, b to the respective logical network, these network interface cards 931a, b may receive messages from the networks 990a, b containing logical network identification information. According to the received logical network identification information, mapping unit 911 may map a corresponding logical network configuration data 921 onto the network interface card 931a, b.

As an example, a logical network within a particular IP subnet and a network role as storage network may be operated within physical network 990a. Physical network 990a may connect computers 901, 902, 903 and 900. These computers 900 and 903 may be operated within the same logical network on the same physical network 990a. As the mapping unit 911 provides automatic mapping of network configuration data onto the network interface card 931, connection of the correct network interface card 931a or 931b to the physical network 990a is not required.

After de-coupling the network interface cards 931a and 931b from the physical networks 990a and 990b, it is possible that cables may become mixed up when reconnecting. Confusion of the cables need not, however, disturb network configuration. Each of the network interface cards 931a and 931b may receive, from the connected physical network 990a and 990b, respective logical network identification information, which allows mapping unit 911 to map the respective logical network configuration data onto the corresponding network interface card 931a, b. In the current example, network interface card 931a may be configured with logical network configuration data 921a in case a logical network configuration information identifying the particular logical network is received on computer 900.

For instance, physical network 990b may operate two different logical networks. These may include a server network, which may operate between computers 906, 905, and a storage network operating between, for example, computers 900 and 904. A tagging unit within physical network 990b (not depicted) may transmit logical network identification information identifying that a storage network is running on physical network 990b. Computer 990 may receive this message through network interface card 931b. In the event that an administrator determines that computer 900 is allowed to be operated within a storage network, this message may be used by the operating system to operate mapping unit 911 to map the corresponding logical network configuration data onto network interface card 931b, thereby enabling network interface card 931b to communicate with other computers of the logical storage network.

When logical network identification information concerning a server network is received while computer 900 is not allowed to be operated in a server network, the received message may be discarded.

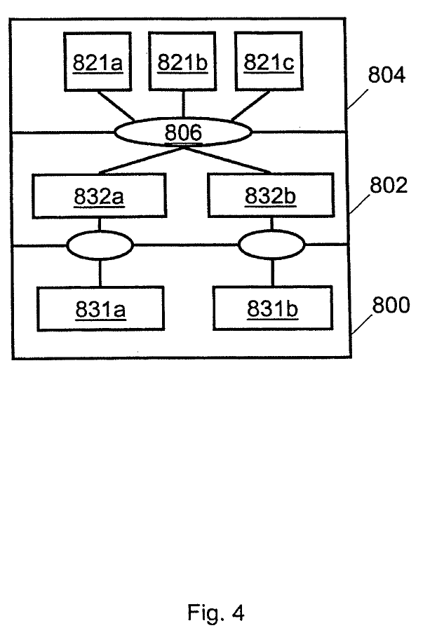

FIG. 4 shows a layer model for implementing a method in accordance with the present invention. Shown are physical layer 800, mapping layer 802, and application layer 804. Mapping layer 802 may comprise functionalities of the OSI reference layers data link, network, transport and/or session.

Representations of network interface cards 831a and 831b are shown within physical layer 800. Service access points 832a and 832b are provided for accessing network interface cards 831a and 831b, which allow mapping layer 802 to access the network interface cards 831a, b. Mapping access point 806 allows application layer 804 to access the service access points 832. Through mapping access point 806, different logical network configuration data 821 may be mapped onto the service access points 832 of network interface cards 831.

Automatic mapping becomes possible when logical network configuration data 821a, b, c are mapped onto service access points 832a, b of network interface cards 832a, b through mapping access point 806. Broadcast messages from the network may be used to determine which logical network configuration data to map onto which service access point 832a, b of network interface card 831a, b. These broadcast messages may comprise logical network identification information.

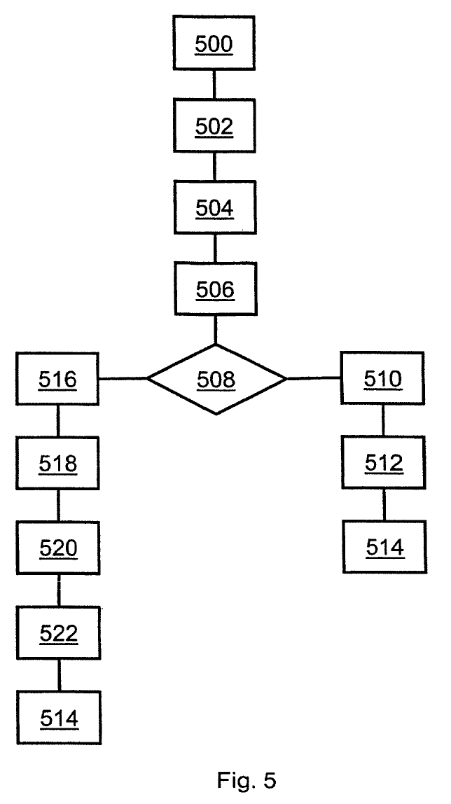

FIG. 5 shows a flowchart of a method in accordance with the present invention. After having installed the computer and determined which logical network the computer should be operated in, the computer may be connected to a physical network. Within the physical network, a logical network identification information message may be broadcasted (500). This broadcast message may be received by every computer connected to the physical network that is listening for broadcast messages (502).

After having received the logical network identification information, this information may be routed to the operating system of the respective computers (504). Within the operating system, the logical network identification information may be analysed to determine which logical network is running on the physical network (506). In the event that the computer is allowed to operate within the logical network based on the logical network identification information received, it is then checked whether a logical network configuration data is available within a storage (508).

In case the logical network configuration data is available within the computer, this logical network configuration data may be loaded (510). The loaded logical network configuration data may then be mapped onto the service access point of the network interface card (512). The network interface card may use the network configuration data, such as IP-address, subnet mask, DHCP server, DNS, gateway, and other information in order to properly operate within the logical network (514).

In case the configuration is not available within the computer (508), a DHCP service may be used to retrieve the required configuration data. Insofar, a DHCP request may be broadcast into the network requesting network configuration data for the logical network for which logical network identification information has been received (516).

A DHCP server within the logical network may respond with a DHCP response to this request and may provide the respective logical network configuration data to the computer (518). After having received the DHCP response, the logical network configuration data may be extracted and stored within the computer (520). At this point, mapping of the data onto the service access point of the network interface card is possible (522). Once mapping is completed, the network interface card and the computer may properly operated within the respective logical network (514).

What is claimed is:

1. A method for providing a network interface within a computer with logical network configuration data, wherein the computer is connected, via the network interface, to at least one physical network, the method comprising:
receiving, within the network interface, logical network identification information from the at least one physical network; and
mapping network configuration data onto the network interface based on the received logical network identification, wherein the mapping enables the network interface to provide communication between the computer and a corresponding logical network.

2. The method of claim 1, wherein the method further comprises routing the received logical network identification information to a mapping unit located within the computer for mapping the network configuration data onto the network interface based on the received logical network identification information.

3. The method of claim 1, wherein the method further comprises providing at least two logical network configuration data sets, wherein each logical network configuration data set enables the network interface to provide communication between the computer and the corresponding logical network.

4. The method of claim 1, wherein the method further comprises storing the network configuration data within the computer and accessing the network configuration data when mapping the network configuration data onto the network interface.

6. The method of claim 1, wherein the method further comprises requesting network configuration data from a server located within at least one of the at least one physical network and the logical network after having received the logical network identification information.

7. The method of claim 1, wherein the method further comprises providing at least two network interface identifications for a single network interface and mapping the network configuration data onto the network interface having corresponding network interface identifications after having received the logical network identification information.

8. The method of claim 1, wherein the method further comprises operating the network interface such that it receives every network message and routes the message to an operating system of the computer.

9. the method of claim 1, wherein the method further comprises running a unit within the at least one physical network, wherein the unit transmits the logical network identification information.

10. The method of claim 9, wherein the unit transmits the logical network identification information in broadcast mode.

11. The method of claim 9, wherein the unit transmits the logical network identification information as faulty broadcasts.

12. A computer arranged for providing a network interface with logical network configuration data, the computer comprising:
at least one network interface card that interfaces the computer with at least one physical network;
a storage arranged for storing at least one logical network configuration data set having logical network configuration data; and
a mapping unit for mapping the logical network configuration data onto the at least one network interface card, wherein the mapping unit is arranged for mapping the logical network configuration data onto the at least one network interface card after reception of a corresponding logical network identification, and wherein the mapping enables the at least one network interface card to provide communication between the computer and a corresponding logical network.

13. A computer-readable medium having stored thereon computer program instructions for causing a computer to perform the method, comprising:
receiving, within the network interface, logical network identification information from the at least one physical network; and
mapping network configuration data onto the network interface based on the received logical network identification information, wherein the mapping enables the network interface to provide communication between the computer and a corresponding logical network.
